(19) United States
(12) Patent Application Publication
(10) Pub. No.: US 2021/0388597 A1
(43) Pub. Date: Dec. 16, 2021

(54) CONSTRUCTION BLOCK COMPRISING PETROLEUM COKE

(71) Applicant: Denis DEUTSCH, Conflans Sainte Honorine (FR)

(72) Inventor: Denis DEUTSCH, Conflans Sainte Honorine (FR)

(21) Appl. No.: 17/416,396

(22) PCT Filed: Dec. 17, 2019
(86) PCT No.: PCT/FR2019/053132

§ 371 Date: Jun. 18, 2021

(30) Foreign Application Priority Data
Dec. 18, 2018 (FR) 1873122

(51) Int. Cl. E04B 1/04; C08K 7/04; C08L 95/00

(52) U.S. Cl. CPC E04B 1/04; C08K 2201/005; C08L 95/005; C08K 7/04

(57) ABSTRACT

The invention relates to a construction block comprising petroleum coke and at least one binder, and having a vertical and/or horizontal water permeability of less than or equal to 0.005 mm/s.

The invention also relates to the use of a composition comprising petroleum coke and at least one binder, for the manufacture of a construction block.

### FIELD OF THE INVENTION

The present invention relates to construction blocks comprising petroleum coke and the use of compositions comprising petroleum coke for the manufacture of construction blocks.

### TECHNICAL BACKGROUND

Petroleum coke is a co-product that is derived from petroleum refining. Various different applications have been developed in order to recycle this product. Thus, at the current time, it is often used as a fuel, or for the production of electrodes. The document EP 2878624 describes a sealing waterproofing membrane that comprises a reinforcing material coated with a composition comprising a mixture of bitumen and plasticiser, petroleum coke and an elastomeric or plastomeric polymer.

On the other hand, construction materials continue to be the subject of constant research with a view to developing a model for sustainable construction.

The document SU 1154299 describes bitumen-based compositions for the production of flooring for agricultural buildings that shelter livestock.

The document CN 105439632 describes a sand-based water-permeable brick that is prepared from a composition comprising petroleum coke. Such a brick, that has high water permeability, would not, for example, be suitable for replacing cinder blocks in the construction of walls.

There is a real need to provide a construction block that is durable, as well as economical and recyclable, which also has good acoustic and thermal insulation properties and can act as a carbon sink.

### SUMMARY OF THE INVENTION

The invention relates firstly, in a fairly general manner, to a construction block comprising petroleum coke and at least one binder.

Optionally, the construction block has a vertical and/or horizontal water permeability of less than or equal to 0.005 mm/s.

In some embodiments, the petroleum coke is present in an amount ranging from 0.1 to 52% by weight, preferably from 5 to 31% by weight, relative to the total weight of the construction block.

In some embodiments, the construction block further comprises aggregates.

In some embodiments, the aggregates are selected from the group consisting of coarse aggregates having a particle size equal to or greater than 6.3 mm, medium aggregates having a particle size greater than 2 mm and less than 6.3 mm, fine aggregates having a particle size of 80 μm to 2 mm, fines having a particle size of less than 80 μm and combinations thereof.

In some embodiments, the construction block comprises as aggregates:
from 0 to 93% by weight, preferably from 5 to 62% by weight, of coarse aggregates having a particle size equal to or greater than 6.3 mm;
from 0 to 93% by weight, preferably from 5 to 62%, by weight of medium aggregates having a particle size greater than 2 mm and less than 6.3 mm;
from 0 to 72% by weight, preferably from 5 to 41%, by weight of fine aggregates having a particle size of 80 μm to 2 mm; and
from 0 to 10% by weight, preferably from 0 to 3% by weight, of fines having a particle size of less than 80 μm;
   relative to the total weight of the construction block.

In some embodiments, the binder is a hydraulic binder, preferably selected from the group consisting of cement, blast furnace slag, pozzolans, fly ash, gypsum, or a mixture thereof, and/or a hydrocarbon binder, preferably selected from the group consisting of bitumen, whether or not modified, pitch, heavy fuel oil, or a mixture thereof, the binder being preferably present in an amount ranging from 0.1 to 41% by weight, even more preferentially from 2 to 26% by weight, relative to the total weight of the construction block.

In some embodiments, the construction block further comprises reinforcing fibres, such as metallic fibres and/or polymer fibres and/or organic fibres, preferably in an amount ranging from 0 to 21% by weight relative to the total weight of the construction block.

The invention also relates to the use of a composition comprising petroleum coke and at least one binder, for the manufacture of a construction block.

In some embodiments, the composition comprises:
from 0.1 to 50% by weight, preferably from 5 to 30% by weight, of petroleum coke;
from 0 to 90% by weight, preferably from 5 to 60% by weight, of coarse aggregates having a particle size equal to or greater than 6.3 mm;
from 0 to 90% by weight, preferably from 5 to 60% by weight, of medium aggregates having a particle size greater than 2 mm and less than 6.3 mm;
from 0 to 70% by weight, preferably from 5 to 40% by weight, of fine aggregates having a particle size of 80 μm to 2 mm;
from 0 to 10% by weight of fines having a particle size of less than 80 μm;
from 0 to 25% by weight, preferably from 1 to 15% by weight, of hydraulic binder;
from 0 to 15% by weight, preferably from 1 to 10% by weight, of hydrocarbon binder;
from 0 to 15% by weight, preferably from 0 to 10% by weight, of water; and
from 0 to 20% by weight of reinforcing fibres, such as metallic fibres and/or polymer fibres and/or organic fibres.

In some embodiments, the hydrocarbon binder is in the form of an emulsion of hydrocarbon binder in water.

The present invention provides the means to satisfy the need specified above. More particularly, it provides a construction block that is economical and recyclable and has good thermal insulation and acoustic insulation properties (superior to those of cement cinder blocks, plaster/gypsum blocks or conventional shuttered and poured concrete). In addition, the construction block according to the invention may be lighter (that is to say that its density may be lower) than a conventional cement construction block (cinder block or concrete slab for example). The construction block according to the invention may also constitute a very significant carbon sink, by absorbing a large quantity of carbon in a sustainable manner. In addition, the construction block according to the invention may exhibit greater fire resistance than that in construction materials such as wood or materials comprising wood, greater solidity than that of plaster (or gypsum) blocks and wood particle boards, as well as greater formability than that of cement or concrete cinder blocks.

This is accomplished thanks to the use of petroleum coke in the construction block.

### BRIEF DESCRIPTION OF THE FIGURES

FIG. 1 is a photo of the compacted block described in Example 1.

FIG. 2 is a photo of the compacted block described in Example 2.

FIG. 3 is a photo of the plates with and without petroleum coke placed on an electric heating device or hotplate, as described in Example 4. The left plate is the plate without petroleum coke, the right plate is the plate with petroleum coke.

FIG. 4 shows the temperature of a volume of water heated through a construction block (plate) without petroleum coke (solid black circles) and the temperature of an identical volume of water heated through a construction block (plate) with petroleum coke (solid gray triangles), as described in Example 4. The abscissa axis represents the time of the measurement (in min), and the ordinate axis represents the temperature of the water (in ° C.).

### DETAILED DESCRIPTION

The invention will be described in greater detail in the description that follows provided without any limitation thereof.

Unless otherwise indicated, all the percentages pertaining to quantities are mass percentages.

In the present application, the (singular) term “a binder” is to be understood to signify “one or more binders”. The same applies to all of the other components.

### Construction Block

The invention relates firstly to a construction block comprising petroleum coke.

The term “construction block” is used to refer to any solid construction element, whether hollow or solid (not hollow). It may in particular be cinder blocks, bricks, vertical or horizontal slabs, or any other block that is capable of undergoing manipulation in order to be assembled with other elements. These blocks may be prefabricated in the factory or may be manufactured on site. These construction blocks are in particular used in the production of walls, foundations, or floors.

Preferably, the construction block has a vertical and/or horizontal water permeability of less than or equal to 0.005 mm/s. The vertical and horizontal water permeabilities may be measured on a cylindrical test piece according to standard NF EN 12697-19. More preferably, the vertical water permeability of the construction block is less than or equal to 0.004 mm/s, or less than or equal to 0.003 mm/s, or less than or equal to 0.002 mm/s, or less than or equal to 0.001 mm/s; and/or the horizontal water permeability of the construction block is less than or equal to 0.004 mm/s, or less than or equal to 0.003 mm/s, or less than or equal to 0.002 mm/s, or less or equal to 0.001 mm/s. This makes it possible for the construction block according to the invention to be used for any type of construction, and in particular for the construction of walls, in particular of buildings. This also allows for better thermal and acoustic insulation.

The construction block according to the invention may have any possible shape or form. According to one advantageous variant, the construction block has a parallelepipedic or substantially parallelepipedic shaped form. The construction block may also have a cylindrical shaped form, or an irregular shaped form. In a particularly preferred manner, the construction block is hollow, that is to say it comprises one or more walls providing for at least one internal cavity, the cavity being open or closed.

The construction block may be sized according to any suitable dimensions. For example, the construction block may have a parallelepipedic shaped form and have a length of 20 to 100 cm, a width of 10 to 50 cm, and a height of 10 to 50 cm. In some examples, the construction block may be a large surface element (facade panel, floor slab).

Petroleum coke (or “petcoke”) is a resultant carbonaceous solid derived from the refining of petroleum and produced by means of a coking process from very heavy petroleum fractions. It can for example be obtained by a process of coking in a fluidised bed (“fluid coking”) or discontinuous coking (“delayed coking”).

Petroleum coke constitutes the ultimate product of petroleum refining, that is to say the product with the highest carbon/hydrogen atomic ratio, typically greater than 25, and therefore having a non-measurable viscosity since the petroleum coke is in solid form.

Petroleum coke being directly output from the coking units is known as “green coke”. This green coke may undergo a calcination process, for example in a rotary kiln, thus making it possible to remove the residual volatile hydrocarbons from the coke: the coke is then referred to “calcined coke”.

In the context of the present invention, the petroleum coke may be either green petroleum coke or calcined petroleum coke. The petroleum coke is preferably green petroleum coke, the latter having the advantage of being more economical.

Preferably, the petroleum coke has a maximum particle size less than or equal to 5 mm, more preferably less than or equal to 3 mm. The particle size of the petroleum coke can be measured by sieving, for example according to standard NF EN 933-1.

The petroleum coke may be considered as a secondary material in accordance with the meaning of standard NF EN 15978 (definition 3.32 of the standard) which describes construction works and the contribution thereof to sustainable development.

The construction block preferably comprises from 0.1 to 52% by weight, preferably from 5 to 31% by weight, of petroleum coke relative to the total weight of the construction block. In some embodiments, the construction block may comprise from 0.1 to 2% by weight, or from 2 to 5% by weight, or from 5 to 10% by weight, or from 10 to 15% by weight, or from 15 to 21% by weight, or from 21 to 26% by weight, or from 26 to 31% by weight, or from 31 to 36% by weight, or from 36 to 41% by weight, or from 41 to 46% by weight, or from 46 to 52% by weight, of petroleum coke relative to the total weight of the construction block.

Preferably, the construction block also comprises aggregates (or granulates).

The term “aggregate” is used to refer to any solid fragment whose maximum dimension is less than 125 mm (as measured by sieving, according to standard NF EN 933-1, for example). In the context of the present invention, this term excludes petroleum coke particles.

The aggregates according to the invention are mineral and/or synthetic aggregates. These aggregates are preferably obtained from the crushing of solid rocks or alluvial rocks. Aggregates therefore refer to a granular material used in construction. An aggregate may be natural, artificial or recycled. The term “natural aggregate” is used to refer to an aggregate that has not undergone any deformation other than mechanical deformation. The term “artificial aggregate” is used to refer to an aggregate of mineral origin resulting from an industrial process comprising of thermal or other transformations. The term “recycled aggregate” is understood to refer to an aggregate that has previously been used whether in construction or in other fields.

The aggregates are advantageously selected from the group consisting of:
coarse aggregates having a particle size greater than or equal to 6.3 mm, preferably less than 2 cm;
medium aggregates having a particle size greater than 2 mm and less than 6.3 mm;
fine aggregates having a particle size of 80 μm to 2 mm;
fines (or fillers) having a particle size of less than 80 μm; and
combinations thereof.

The size (or diameter) of particles of the aggregates may be measured by sieving, for example according to standard NF EN 933-1, or by laser granulometry.

The construction block may comprise from 0 to 93% by weight of coarse aggregates, preferably from 5 to 62%, relative to the total weight of the construction block. In some embodiments, the construction block may comprise from 0 to 10% by weight, or from 10 to 21% by weight, or from 21 to 31% by weight, or from 31 to 41% by weight, or from 41 at 52% by weight, or from 52 to 62% by weight, or from 62 to 72% by weight, or from 72% to 82% by weight, or from 82% to 93% by weight, of coarse aggregates, relative to the total weight of the construction block.

The construction block can also comprise from 0 to 93% by weight of medium aggregates, preferably from 5 to 62%, relative to the total weight of the construction block. In some embodiments, the construction block may comprise from 0 to 10% by weight, or from 10 to 21% by weight, or from 21 to 31% by weight, or from 31 to 41% by weight, or from 41 at 52% by weight, or from 52 to 62% by weight, or from 62 to 72% by weight, or from 72% to 82% by weight, or from 82% to 93% by weight, of medium aggregates, relative the total weight of the construction block.

The construction block may also comprise from 0 to 72% by weight of fine aggregates, preferably from 5 to 41%, relative to the total weight of the construction block. In some embodiments, the construction block may comprise from 0 to 2% by weight, or from 2 to 5% by weight, or from 5 to 10% by weight, or from 10 to 15% by weight, or from 15 to 21% by weight, or from 21 to 26% by weight, or from 26 to 31% by weight, or from 31 to 36% by weight, or from 36 to 41% by weight, or from 41 to 46% by weight, or from 46 to 52% by weight, or from 52 to 57% by weight, or from 57 to 62% by weight, or from 62 to 67% by weight, or from 67 to 72% by weight, of fine aggregates relative to the total weight of the construction block.

The construction block may also comprise from 0 to 10% by weight, preferably from 0 to 3% by weight, of fines. In some embodiments, the construction block may comprise from 0 to 1% by weight, or from 1 to 2% by weight, or from 2 to 3% by weight, or from 3 to 4% by weight, or from 4 to 5% by weight, or from 5 to 6% by weight, or from 6 to 7% by weight, or from 7 to 8% by weight, or from 8 to 9% by weight, or from 9 to 10% by weight, of fines relative to the total weight of the construction block.

The aggregates belonging to the categories described here above (coarse aggregates, medium aggregates, fine aggregates and fines) may be similar or different in nature from one category to another. Likewise, the aggregates, in each of the categories described here above, may all be similar in nature or different in nature.

The aggregates, regardless of the category to which they belong, may comprise, or be composed of, for example, limestone, silica, and/or magmatic or plutonic rock.

The aggregates may, in whole or in part, be fragments of bituminous (or asphalt) mix deriving from the road industry, for example millings derived from the recycling of bituminous mix, gravel and road asphalt, with the exception of those containing asbestos fibres, and/or fragments of crushed construction material deriving from the construction industry. The term “bituminous mix” is used to refer to a mixture of a bituminous binder composition with aggregates. Such fragments may comprise a certain proportion of hydrocarbon binder. In this case, the hydrocarbon binder in question is taken into account with the hydrocarbon binder provided separately, for the purposes of calculating the proportions of the various compounds of the mix. The fragments of bituminous mix deriving from the road industry and/or the fragments of crushed construction material deriving from the construction industry may for example be present in a proportion ranging from 0 to 10% by weight, or from 10 to 21% by weight, or from 21 to 31% by weight, or from 31 to 41% by weight, or from 41 to 52% by weight, or from 52 to 62% by weight, or from 62 to 72% by weight, or from 72% to 82% by weight, or from 82% to 93% by weight, relative to the total weight of the construction block. The preferred ranges are from 5 to 62%, or from 15 to 51%, by weight, relative to the total weight of the construction block.

The aggregates, in whole or in part, may also comprise, or be composed of, polymers. These may in particular be recovered plastics and/or recovered rubber. Adding polymer to the construction block can make it possible to increase the elasticity of the construction block and/or its thermal and/or acoustic insulation capacity. Preferably, the aggregates that comprise, or are composed of, polymers, are present in a mass quantity ranging from 0 to 21% by weight, more preferably from 0 to 10% by weight, for example from 0 to 5%, or from 5 to 10%, or from 10 to 15%, or from 15 to 21%, by weight, relative to the total weight of the construction block.

The fine aggregates may in particular be sand.

The construction block also includes at least one binder. The term “binder” is used to refer to a product that enables the agglomeration of all or part of the solid elements constituting the construction block.

Advantageously, the construction block comprises from 0.1 to 41% by weight of binder, preferably from 2 to 26% by weight, even more preferably from 2 to 12% by weight, relative to the total weight of the construction block. In some embodiments, the construction block may comprise from 0.1 to 2% by weight, or from 2 to 4% by weight, or from 4 to 6% by weight, or from 6 to 8% by weight, or from 8 to 10% by weight, or from 10 to 15% by weight, or from 15 to 21% by weight, or from 21 to 26% by weight, or from 26 to 31% by weight, or from 31 to 36% by weight, or from 36 to 41% by weight, of binder relative to the total weight of the construction block.

The binder may be cement (hydrated). The presence of cement can serve to increase the hardness of the construction block.

Alternatively, or in partial substitution, the binder may be another hydraulic binder, such as in particular blast furnace slag, fly ash, pozzolans and/or gypsum.

Alternatively, or in addition, the binder may be a hydrocarbon binder. The term “hydrocarbon binder” is used to refer to any binder comprising one or more hydrocarbons. In the context of the present invention, this term excludes petroleum coke. The hydrocarbon binder is considered as a secondary material in accordance with the meaning of standard NF EN 15978 (definition 3.32 of the standard) which describes construction works and the contribution thereof to sustainable development.

The hydrocarbon binder is advantageously selected from the group consisting of bitumen, whether or not modified, pitch, heavy fuel oil or a mixture thereof.

The bitumen preferably has a penetrability of less than 800 tenths of 1 mm at 25° C., as measured according to the standard NF EN 1426. The bitumens according to the invention include the bitumens of natural origin, those contained in natural bitumen deposits, natural asphalt deposits, or oil sands. The bitumens according to the invention also include the bitumens deriving from the refining of crude oil. Bitumens are derived from the atmospheric and/or vacuum distillation of petroleum. It is possible for these bitumens to optionally be blown, visbroken and/or derived from the deasphalting process. The various different bitumens obtained by the refining processes may be combined with one another. The bitumens may be hard grade or soft grade bitumens.

Heavy fuel oil and pitch are also derived from the atmospheric and/or vacuum distillation of petroleum. They are essentially used as fuel. Pitch differs from heavy fuel oil by its higher viscosity, going up to 4000 mm²/s for kinematic viscosity at 50° C. (measured for example according to standard NF EN ISO 3104). Pitch is thus also known as “high viscosity fuel”.

Preferably, the hydrocarbon binder is pitch. Pitch offers the advantage of being more economical than bitumen and heavy fuel oil.

In a particularly preferred manner, the binder comprises a hydraulic binder and a hydrocarbon binder. For example, the construction block comprises from 0 to 26% by weight, preferably from 1 to 15% by weight, of hydraulic binder and from 0 to 15% by weight, preferably from 1 to 10% by weight, of hydrocarbon binder relative to the total weight of the construction block.

In some embodiments, the construction block comprises from 0 to 0.5% by weight, or from 0.5 to 1% by weight, or from 1 to 2% by weight, or from 2 to 3% by weight, or from 3 to 4% by weight, or from 4 to 5% by weight, or from 5 to 6% by weight, or from 6 to 7% by weight, or from 7 to 8% by weight, or from 8 to 9% by weight, or from 9 to 10% by weight, or from 10 to 12% by weight, or from 12 to 14% by weight, or from 14 to 16% by weight, or from 16 to 19% by weight, or from 19 to 21% by weight, or from 21 to 23% by weight, or from 23 to 25% by weight, or from 25 to 26% by weight, of hydraulic binder, relative to the total weight of the construction block.

In some embodiments, the construction block comprises from 0 to 1% by weight, or from 1 to 2% by weight, or from 2 to 3% by weight, or from 3 to 4% by weight, or from 4 to 5% by weight, or from 5 to 6% by weight, or from 6 to 7% by weight, or from 7 to 8% by weight, or from 8 to 9% by weight, or from 9 to 10% by weight, or from 10 to 11% by weight, or from 11 to 12% by weight, or from 12 to 13% by weight, or from 13 to 14% by weight, or from 14 to 15% by weight, of hydrocarbon binder relative to the total weight of the construction block.

The quantities of binder indicated here above refer to the quantity of the binder as such and do not take into account any additives that may be incorporated into the binder, for example in order to facilitate addition thereof with the other constituents of the block, for example water, when the hydrocarbon binder is introduced in the form of an emulsion into the composition intended for the manufacture of the block.

The hydrocarbon binder (as such) preferentially has a kinematic viscosity at 50° C. that is greater than or equal to 50 mm²/s, even more preferentially greater than or equal to 100 mm²/s, for example from 50 to 100 mm²/s, or from 100 to 500 mm²/s, or from 500 to 1000 mm²/s, or from 1000 to 1500 mm²/s, or from 1500 to 2000 mm²/s, or from 2000 to 2500 mm²/s, or from 2500 to 3000 mm²/s, or from 3000 to 3500 mm²/s, or from 3500 to 4000 mm²/s, or greater than 4000 mm²/s. The kinematic viscosity may be measured at 50° C. according to standard NF EN ISO 3104.

The construction block may also include reinforcing fibres, such as metallic fibres and/or polymer fibres and/or organic fibres. These reinforcing fibres are preferably present in an amount ranging from 0 to 21% by weight, more preferably from 0 to 10% by weight, for example from 0 to 5%, or from 5 to 10%, or from 10 to 15%, or from 15 to 21%, by weight, relative to the total weight of the construction block.

The construction block may also include other additives. These additives for example may be emulsifying agents and/or concrete admixtures, preferably in an amount ranging from 0 to 1% by weight, for example from 0.01 to 1% by weight, relative to the total weight of the construction block.

According to certain embodiments, the construction block substantially consists, or consists, of the compounds described here above.

The construction block according to the invention can be recycled, one or more times, for example as aggregates. Thus, the construction block may be ground and/or crushed, so as to obtain fragments of smaller size. These fragments may then be screened with a view to selection based on their size. They may, for example, be reused as coarse aggregates, as medium aggregates, as fine aggregates and/or as fines.

The invention also relates to the use of a construction block as defined here above, for the construction of walls, foundations, or masonry flooring. The walls and flooring may be either interior or exterior walls or flooring.

The object of the invention also relates to a wall, a foundation or a masonry flooring comprising at least one construction block as defined here above.

### Manufacture of a Construction Block

The invention also relates to the use of petroleum coke for the manufacture of a construction block. The petroleum coke is present in a composition, in combination with at least one binder.

Preferably, the composition comprises:
from 0.1 to 50% by weight of petroleum coke;
from 0 to 90% by weight of coarse aggregates having a particle size equal to or greater than 6.3 mm;
from 0 to 90% by weight of medium aggregates having a particle size greater than 2 and less than 6.3 mm;
from 0 to 70% by weight of fine aggregates having a particle size of 80 μm to 2 mm;
from 0 to 10% by weight of fines having a particle size of less than 80 μm;
from 0 to 25% by weight of hydraulic binder;
from 0 to 15% by weight of hydrocarbon binder;
from 0 to 15% water; and
from 0 to 20% of reinforcing fibres, such as metallic fibres and/or polymer fibres and/or organic fibres;
   for the manufacture of a construction block.

Preferably, the composition for manufacturing the construction block comprises at least 0.1% of binder (hydraulic binder and/or hydrocarbon binder).

The characteristics pertaining to the nature and the particle sizes of the components of the construction block described here above can also apply to the composition used for the manufacture of the construction block.

In a manner similar to that which has been indicated here above, the quantities of binder indicated refer to the quantities of binder as such.

The particle size of the aggregates or petroleum coke can be measured by sieving or laser granulometry, as described here above.

Preferably, the composition for manufacturing the construction block comprises:
from 5 to 30% by weight of petroleum coke;
from 5 to 60% by weight of coarse aggregates having a particle size equal to or greater than 6.3 mm;
from 5 to 60% by weight of medium aggregates having a particle size greater than 2 mm and less than 6.3 mm;
from 5 to 40% by weight of fine aggregates having a particle size of 80 μm to 2 mm;
from 1 to 15% by weight of hydraulic binder;
from 1 to 10% by weight of hydrocarbon binder; and
from 0 to 10% by weight of water.

The composition for use thereof for the manufacture of a construction block may comprise from 0.1 to 2% by weight, or from 2 to 5% by weight, or from 5 to 10% by weight, or from 10 to 15% by weight, or from 15 to 20% by weight, or from 20 to 25% by weight, or from 25 to 30% by weight, or from 30 to 35% by weight, or from 35 to 40% by weight, or from 40 to 45% by weight, or from 45 to 50% by weight, of petroleum coke relative to the total weight of the composition.

The composition may comprise from 0 to 10% by weight, or from 10 to 20% by weight, or from 20 to 30% by weight, or from 30 to 40% by weight, or from 40 to 50% by weight, or from 50 to 60% by weight, or from 60 to 70% by weight, or from 70% to 80% by weight, or from 80% to 90% by weight, of coarse aggregates, relative to the total weight of the composition.

The composition may comprise from 0 to 10% by weight, or from 10 to 20% by weight, or from 20 to 30% by weight, or from 30 to 40% by weight, or from 40 to 50% by weight, or from 50 to 60% by weight, or from 60 to 70% by weight, or from 70% to 80% by weight, or from 80% to 90% by weight, of medium aggregates, relative to the total weight of the composition.

The composition may comprise from 0 to 2% by weight, or from 2 to 5% by weight, or from 5 to 10% by weight, or from 10 to 15% by weight, or from 15 to 20% by weight, or from 20 to 25% by weight, or from 25 to 30% by weight, or from 30 to 35% by weight, or from 35 to 40% by weight, or from 40 to 45% by weight, or from 45 to 50% in weight, or from 50 to 55% by weight, or from 55 to 60% by weight, or from 60 to 65% by weight, or from 65 to 70% by weight, of fine aggregates relative to the total weight of the composition.

The composition may comprise from 0 to 1% by weight, or from 1 to 2% by weight, or from 2 to 3% by weight, or from 3 to 4% by weight, or from 4 to 5% by weight, or from 5 to 6% by weight, or from 6 to 7% by weight, or from 7 to 8% by weight, or from 8 to 9% by weight, or from 9 to 10% by weight, of fines relative to the total weight of the composition.

The composition may comprise from 0 to 0.5% by weight, or from 0.5 to 1% by weight, or from 1 to 2% by weight, or from 2 to 3% by weight, or from 3 to 4% by weight, or from 4 to 5% by weight, or from 5 to 6% by weight, or from 6 to 7% by weight, or from 7 to 8% by weight, or from 8 to 9% by weight, or from 9 to 10% by weight, or from 10 to 12% by weight, or from 12 to 14% by weight, or from 14 to 16% by weight, or from 16 to 18% by weight, or from 18 to 20% by weight , or from 20 to 22% by weight, or from 22 to 24% by weight, or from 24 to 25% by weight, of hydraulic binder, relative to the total weight of the composition.

The composition may comprise from 0 to 1% by weight, or from 1 to 2% by weight, or from 2 to 3% by weight, or from 3 to 4% by weight, or from 4 to 5% by weight, or from 5 to 6% by weight, or from 6 to 7% by weight, or from 7 to 8% by weight, or from 8 to 9% by weight, or from 9 to 10% by weight, or from 10 to 11% by weight, or from 11 to 12% by weight, or from 12 to 13% by weight, or from 13 to 14% by weight, or from 14 to 15% by weight, of hydrocarbon binder relative to the total weight of the composition.

The composition may comprise from 0 to 2% by weight, or from 2 to 4% by weight, or from 4 to 6% by weight, or from 6 to 8% by weight, or from 8 to 10% by weight, or from 10 to 12% by weight, or from 12 to 15% by weight, of water relative to the total weight of the composition.

The composition may comprise from 0 to 5%, or from 5 to 10%, or from 10 to 15%, or from 15 to 20% by weight, of reinforcing fibres, relative to the total weight of the composition.

The composition may also comprise other additives, for example one or more emulsifying agents and/or concrete admixtures, preferably in an amount ranging from 0 to 1% by weight, for example from 0.01 to 1% by weight, relative to the total weight of the composition.

Aggregates consisting of fragments of bituminous mix deriving from the road industry and/or fragments of crushed construction material deriving from the construction industry may be present in the composition, for example in an amount ranging from 0 to 10% by weight, or from 10 to 20% by weight, or from 20 to 30% by weight, or from 30 to 40% by weight, or from 40 to 50% by weight, or from 50 to 60% by weight, or from 60 to 70% by weight, or from 70% to 80% by weight, or from 80% to 90% by weight, relative to the total weight of the composition. Preferably, they are present in an amount ranging from 5 to 60% by weight, or from 15 to 50% by weight, relative to the total weight of the composition.

Aggregates that comprise, or are composed of, polymers, may be present in the composition, preferably in an amount ranging from 0 to 20% by weight, more preferentially from 0 to 10% by weight, for example from 0 to 5%, or from 5 to 10%, or from 10 to 15%, or from 15 to 20%, by weight, relative to the total weight of the composition.

In certain embodiments, the composition substantially consists, or consists, of the composition as described here above.

The composition may be prepared by the mixing, in one or more steps, of the components. According to one preferred variant, the components are mixed using a mixing device of such type as a mixer. Preferably, the mixing of the components is carried out at ambient temperature but it may alternatively be carried out at a higher temperature, for example if the hydrocarbon binder is introduced hot.

Preferably, the petroleum coke is mixed with the aggregates, that is to say it is for example mixed with the coarse aggregates, with the medium aggregates, with the fine aggregates, and/or with the fines, and/or with the hydraulic binder, and/or with the hydrocarbon binder, and/or with water, and/or with the additives (reinforcing fibres and/or other additives). The above-mentioned components may be introduced into the mixture in any order whatsoever, or all at the same time, or partially at the same time. Certain of these components may be premixed before being admixed with the other components.

The coarse aggregates, the medium aggregates, the fine aggregates, and the fines that are mixed in order to prepare the composition used for the manufacture of a construction block are as described here above, with regard to the nature and the granulometry thereof.

The petroleum coke is preferably ground in advance prior to mixing with the other components.

The hydrocarbon binder may be incorporated into the mixture in the form of an emulsion of hydrocarbon binder in water. Hydrocarbon binder emulsions are well known to the person skilled in the art. Preferably, the emulsion comprises from 50 to 90%, preferably from 60 to 85%, by weight of hydrocarbon binder; from 10 to 50%, preferably from 15 to 40%, by weight of water; and optionally one or more emulsifying agents, preferably in an amount of less than 1% by weight, for example from 0.01 to 1% by weight. The emulsion preferably has a viscosity ranging from 5 to 500 s (corresponding to the flow time with a 4 mm orifice, at 40° C., measured according to standard NF EN 12846-1).

The emulsion may be prepared either just prior to mixing with the other components or farther upstream from the mixing. The first case is advantageous given that it is then not necessary to obtain an emulsion having a significant level of stability, which makes it possible to decrease the quantity of emulsifying agents used, or indeed even to eliminate them completely.

Preferably, when the hydrocarbon binder is incorporated into the mixture in the form of an emulsion, the emulsion is introduced at ambient temperature, (that is to say at a temperature of 15 to 30° C.), or, alternatively, the emulsion is pre-heated in advance to a temperature of up to 90° C. The introduction of the hydrocarbon binder in the form of an emulsion can make it possible to facilitate the binding of the binder, in particular to petroleum coke. In addition, the use of a hydrocarbon binder emulsion can make it possible to avoid hot mixing of the binder.

The hydrocarbon binder may also be incorporated into the mixture in pure form. In this case, it is advantageously pre-heated in advance to a temperature ranging from 50 to 100° C., or, alternatively, to a temperature ranging from 100 to 200° C.

When a hydrocarbon binder is introduced into the mixture in the form of an emulsion, it is preferably incorporated after the other components, at the end of the mixing step.

In some embodiments, the petroleum coke is agglomerated by means of all or part of the hydrocarbon binder prior to its introduction into the mixture.

The invention also relates to a method for manufacturing a construction block. This method includes:
providing a composition as described here above in a mould; and
hardening the composition.

During this manufacturing method, the composition generally loses a portion of its water, if the initial composition comprises a quantity of water or hydrocarbon binder emulsion, typically in the order of 2 to 5% of its initial weight.

The method for manufacturing the construction block may also include a step of compacting the composition in the mould, preferably between the step of providing the composition in a mould (for example after the introduction of the composition into the mould) and the step of hardening the composition.

The compaction of the composition, when it is carried out, is preferably carried out by making use of a stationary press, a vibrating press, or a block making machine. The use of vibration makes it possible to increase the compaction.

The hardening (or “maturing”) is preferably carried out by leaving the composition to stand for a period of several hours, more preferably between 24 and 48 hours.

Advantageously, the step of hardening is carried out at ambient temperature, by leaving the composition to stand in ambient air. Optionally, the hardening step may be carried out in a oven. During the step of hardening, the composition dries and solidifies. The hydraulic binder, where present, hardens upon hydration and the emulsion, where present, gets broken.

The manufacturing method advantageously comprises a step of demoulding the composition, preferably after the compacting step when a compacting step is present, and before the step of hardening. In other embodiments, the demoulding step is performed after the hardening step.

The method for manufacturing the construction block, in particular for a non-prefabricated, large dimensioned block, may be implemented on site, for example by means of formwork. The hardening and demoulding are then carried out on site.

### EXAMPLES

The following examples illustrate the invention and are provided without any limitation thereof.

### Example 1

A composition is prepared by mixing the following components, in the mass quantities indicated:
Crushed recovered bituminous mix (with particle size of 0 to 15 mm): 34%;
Mineral aggregates (with particle size of 6 to 10 mm): 35%;
Sand (with particle size of 0 to 2 mm): 5%;
Petroleum coke (with particle size of 0 to 4 mm): 9%;
Cement: 4%;
Water: 8%;
Bitumen emulsion (having 67% by weight of dry hydrocarbon binder): 5%

The particle sizes of the aggregates and petroleum coke are measured according to standard NF EN 933-1.

All of the components, including the petroleum coke and cement, but with the exception of the aqueous components (water and emulsion), are introduced simultaneously into a mixer in order to be intimately mixed therein. Immediately thereafter the water and the hydrocarbon binder emulsion are incorporated so as to undergo yet another vigorous mixing.

The composition is subsequently compacted into a cylindrical block measuring approximately 9 cm in diameter and approximately 4 cm in height, with a weight of approximately 0.5 kg. In order to do this, the process implemented is as in the Marshall test described in the standard EN 12697-34 for compacting by means of a mass each of the circular surfaces of the block.

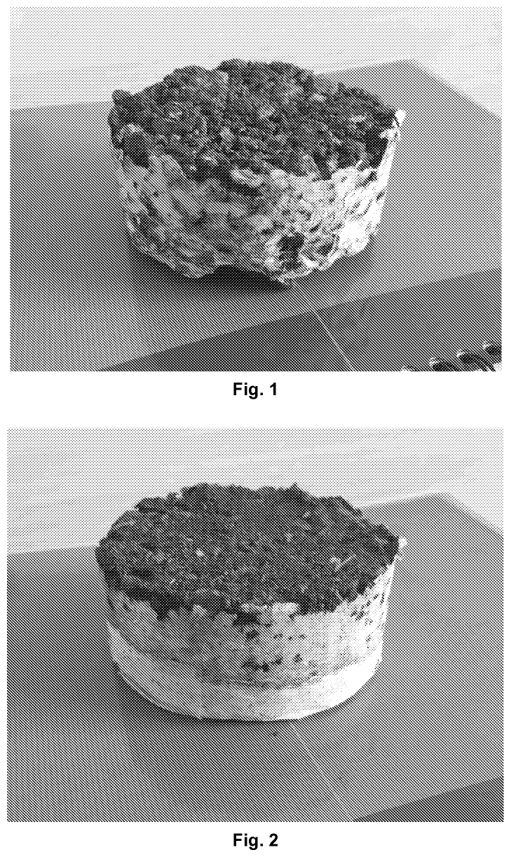

The result is shown in FIG. 1. The white element surrounding the block is paper, added so as to facilitate the demoulding of the block in this example.

### Example 2

A composition is prepared by mixing the following components, in the mass quantities indicated:
Aggregates (with a particle size of 4 to 6 mm): 35%;
Sand (with particle size of 0 to 2 mm): 30%;
Petroleum coke (with particle size of 0 to 4 mm): 20%;
Cement: 4%;
Water: 5%;
Bitumen emulsion (having 67% by weight of dry hydrocarbon binder): 6%.

The particle sizes of the aggregates and petroleum coke are measured according to standard NF EN 933-1.

The composition is prepared, and subsequently compacted into a cylindrical block measuring approximately 9 cm in diameter and approximately 4 cm in height, with a weight of approximately 0.5 kg, as described in Example 1.

The result is shown in FIG. 2. The white element surrounding the block is paper, added so as to facilitate the demoulding of the block in this example.

### Example 3

The following composition for the manufacture of a construction block is prepared, in the mass quantities indicated:
Aggregates (with a particle size of 6-10 mm): 56%;
Aggregates (with a particle size of 2-4 mm): 20%;
Sand: 6%;
Petroleum coke (with a particle size of 0 to 4 mm): 10%
Cement: 3%;
Pitch emulsion (having 67% by weight of dry hydrocarbon binder): 5%.

The particle sizes of the aggregates and petroleum coke are measured according to standard NF EN 933-1.

The composition is prepared in the manner described in Example 1.

The construction materials described in the examples here above comprise a significant proportion of petroleum coke and hydrocarbon binder: they therefore represent a very significant carbon sink. For example, for the construction material in Example 2, one ton of the dry final product sequesters about 225 kg of carbon, which amounts to a CO2 equivalent of about 800 kg.

### Example 4

The construction blocks, in the form of plates, are prepared in a mould having dimensions of 21.5×14.3×2.3 cm and with a volume of 0.707 L, from the following mixtures:

| | Mixture without | Mixture with Petro- |
|---|---|---|
| | Petroleum Coke | leum Coke |
| Ready-to-use mortar (g) | 900 | 1200 |
| Cement (g) | 150 | 100 |
| Sand (g) | 750 | 0 |
| Petroleum coke (g) | 0 | 333 |
| Water (g) | 225 | 220 |

Two plates are prepared respectively from the two mixtures. After the setting and drying (hardening) of the plates, the plate without petroleum coke and the plate with petroleum coke have a weight of 1350 g and 1295 g respectively and an approximate density of 1.909 g/cm³ and of 1.804 g/cm³ respectively.

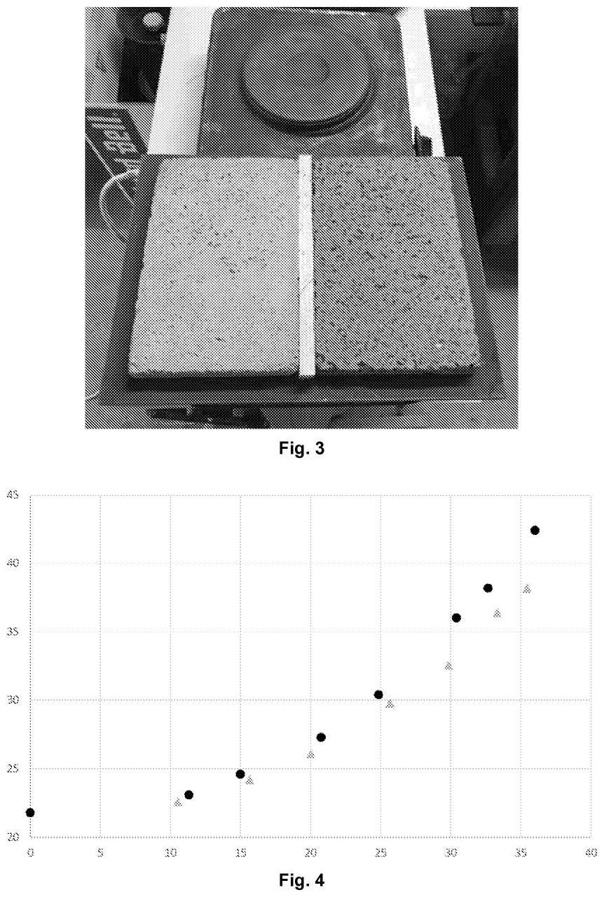

Both plates are tested for their heat transfer property. In order to do this, the two plates are placed on an electric heater, as shown in FIG. 3. Then a certain volume of water is maintained in a container on the upper face of each of the plates, while the plates are heated together on their underside surface. The temperature of the 2 identical volumes of water on each of the plates is measured over time.

The results are shown in FIG. 4.

It is found that the rise in water temperature is significantly lower in the case of the plate with petroleum coke than in the case of the plate without petroleum coke. The thermal conductivity of the plate with petroleum coke is about 18% lower than that of the plate without petroleum coke. The plate with petroleum coke therefore has better thermal insulation than the plate without petroleum coke.

1. A construction block comprising petroleum coke and at least one binder and having a vertical and/or horizontal water permeability of less than or equal to 0.005 m m/s.

2. The construction block according to claim 1, wherein the petroleum coke is present in an amount ranging from 0.1 to 52% by weight, relative to the total weight of the construction block.

3. The construction block according to claim 1, that further comprises aggregates.

4. The construction block according to claim 3, wherein the aggregates are selected from the group consisting of coarse aggregates having a particle size equal to or greater than 6.3 mm, medium aggregates having a particle size greater than 2 mm and less than 6.3 mm, fine aggregates having a particle size of 80 μm to 2 mm, fines aggregates having a particle size of less than 80 μm and combinations thereof.

5. The construction block according to claim 3, that comprises as aggregates:
from 0 to 93% by weight, of coarse aggregates having a particle size equal to or greater than 6.3 mm;
from 0 to 93% by weight, by weight of medium aggregates having a particle size greater than 2 mm and less than 6.3 mm;
from 0 to 72% by weight, by weight of fine aggregates having a particle size of 80 μm to 2 mm; and
from 0 to 10% by weight, of fines having a particle size of less than 80 μm;
relative to the total weight of the construction block.

6. The construction block according to claim 1, wherein the binder is selected from the group consisting of a hydraulic binder, and a combination thereof.

7. The construction block according to claim

8. A method for manufacturing a construction block comprising providing a composition comprising petroleum coke and at least one binder and hardening the composition.

9. The method according to claim 8, wherein the composition comprises:
from 0.1 to 50% by weight, of petroleum coke;
from 0 to 90% by weight, of coarse aggregates having a particle size equal to or greater than 6.3 mm;
from 0 to 90% by weight, of medium aggregates having a particle size greater than 2 mm and less than 6.3 mm;
from 0 to 70% by weight, of fine aggregates having a particle size of 80 μm to 2 mm;
from 0 to 10% by weight of fines having a particle size of less than 80 μm;
from 0 to 25% by weight, of hydraulic binder;
from 0 to 15% by weight, of hydrocarbon binder;
from 0 to 15% by weight, of water; and
from 0 to 20% by weight of reinforcing fibres.

10. The method according to claim 8, wherein the hydrocarbon binder is in the form of an emulsion of hydrocarbon binder in water.

11. The construction block according to claim 1, wherein the petroleum coke is present in an amount ranging from 5 to 31% by weight, relative to the total weight of the construction block.

12. The construction block according to claim 3, that comprises as aggregates:
from 5 to 62% by weight of coarse aggregates having a particle size equal to or greater than 6.3 mm;
from 5 to 62%, by weight of medium aggregates having a particle size greater than 2 mm and less than 6.3 mm;
from 5 to 41%, by weight of fine aggregates having a particle size of 80 μm to 2 mm; and
from 0 to 3% by weight of fines having a particle size of less than 80 μm;
relative to the total weight of the construction block.

13. The construction block according to claim 6, wherein the hydraulic binder is selected from the group consisting of cement, blast furnace slag, pozzolans, fly ash, gypsum, or a mixture thereof.

14. The construction block according to claim 6, wherein the hydrocarbon binder is selected from the group consisting of bitumen, whether or not modified, pitch, heavy fuel oil, or a mixture thereof.

15. The construction block according to claim 1, wherein the binder is present in an amount ranging from 0.1 to 41% by weight, relative to the total weight of the construction block.

16. The construction block according to claim 1, wherein the binder is present in an amount ranging from 2 to 26% by weight, relative to the total weight of the construction block.

17. The construction block according to claim 7, wherein the reinforcing fibres are metallic fibres and/or polymer fibres and/or organic fibres.

18. The construction block according to claim 7, wherein the reinforcing fibres are in an amount ranging from 0 to 21% by weight, relative to the total weight of the construction block.

19. The method according to claim 8, wherein the reinforcing fibres are metallic fibres and/or polymer fibres and/or organic fibres.

20. The method according to claim 8, in which the composition comprises:
from 5 to 30% by weight of petroleum coke;
from 5 to 60% by weight of coarse aggregates having a particle size equal to or greater than 6.3 mm;
from 5 to 60% by weight of medium aggregates having a particle size greater than 2 mm and less than 6.3 mm;
from 5 to 40% by weight of fine aggregates having a particle size of 80 μm to 2 mm;
from 0 to 10% by weight of fines having a particle size of less than 80 μm;
from 1 to 15% by weight of hydraulic binder;
from 1 to 10% by weight of hydrocarbon binder;
from 0 to 10% by weight of water; and
from 0 to 20% by weight of reinforcing fibres.
